(19) United States
(12) Patent Application Publication
(10) Pub. No.: US 2010/0318533 A1
(43) Pub. Date: Dec. 16, 2010

(54) ENRICHED DOCUMENT REPRESENTATIONS USING AGGREGATED ANCHOR TEXT

(75) Inventors: Jasmine Novak, Redwood City, CA (US); Donald Metzler, Santa Clara, CA (US); Hang Cui, San Jose, CA (US); Srihari Reddy, Santa Clara, CA (US); Emre Velipasaoglu, San Francisco, CA (US)

Correspondence Address: HICKMAN PALERMO TRUONG & BECKER LLP/Yahoo! Inc., 2055 Gateway Place, Suite 550, San Jose, CA, 95110-1083, US

(73) Assignee: YAHOO! INC., Sunnyvale, CA (US)

(21) Appl. No.: 12/482,377

(22) Filed: Jun. 10, 2009

(51) Int. Cl. G06F 17/00; G06F 17/30

(52) U.S. Cl. 707/759; 715/205; 707/713

(57) ABSTRACT

A system and method for aggregating anchor text over the web graph and using the aggregated anchor text to enrich document representations. For a target page, its internal inlinks, which point to the target page and are within the site containing the target page, are identified first. Then external anchors that point to the internal inlinks from pages outside of the site are identified. Anchor text of the external anchors are collected, weighted, stored, and used to enrich document presentations. The method not only reduces the number of pages with no anchor text, but also adds lines of anchor text to URLs.

### BACKGROUND

1. Field of the Invention

The present invention relates generally to document search, and more particularly to improving ranking results and retrieval effectiveness by enriching document representations.

2. Description of Related Art

One of the most unique characteristics of the web is its dynamic, human generated hypertext structure. The web has allowed millions of everyday users to publish their own content. Most web pages contain one or more hyperlinks that point to other pages. These hyperlinks, referred to as anchors, may consist of a destination URL and a short piece of text. The short piece of text, which is called anchor text, typically provides a description of the destination URL. For example, the anchor text associated with a hyperlink to the page http://www.acm.org/sigir may include “sigir,” “acm sigir,” and “information retrieval.”

Anchor text is useful because it is similar in nature to queries. In the ACM SIGIR homepage example above, it is easy to see that the anchor text “sigir,” “acm sigir,” and “information retrieval” are reasonable queries that users may enter when they are searching for the page.

However, anchor text sparsity prevents anchor text from being used effectively in Internet search. Currently, many useful pages have very little, or no, anchor text. Therefore, it may be desirable to provide a system and method which may overcome the anchor text sparsity problem by enriching document representations by using aggregated anchor text, especially for those documents that have little or no anchor text to begin with.

### BRIEF DESCRIPTION OF THE DRAWING FIGURES

Embodiments of the present invention are described herein with reference to the accompanying drawings, similar reference numbers being used to indicate functionally similar elements.

FIG. 1 illustrates a system for enriching document representations with aggregated anchor text according to one embodiment of the present invention.

FIG. 2 illustrates a web graph over which anchor text may be aggregated according to one embodiment of the present invention.

FIG. 3 is a flow chart of a method for aggregating anchor text over the web graph according to one embodiment of the present invention.

FIG. 4 illustrates an example of data stored in an anchor text database according to one embodiment of the present invention.

FIG. 5 illustrates a document representation.

FIG. 6 is a flow chart of a method for using aggregated anchor text to improve Internet search according to one embodiment of the present invention.

### DETAILED DESCRIPTION

The present invention provides a system and method for enriching document representations by augmenting documents with auxiliary anchor text that is derived by aggregating, or propagating, anchor text over the web graph. The invention may be carried out by computer-executable instructions, such as program modules. Advantages of the present invention will become apparent from the following detailed description.

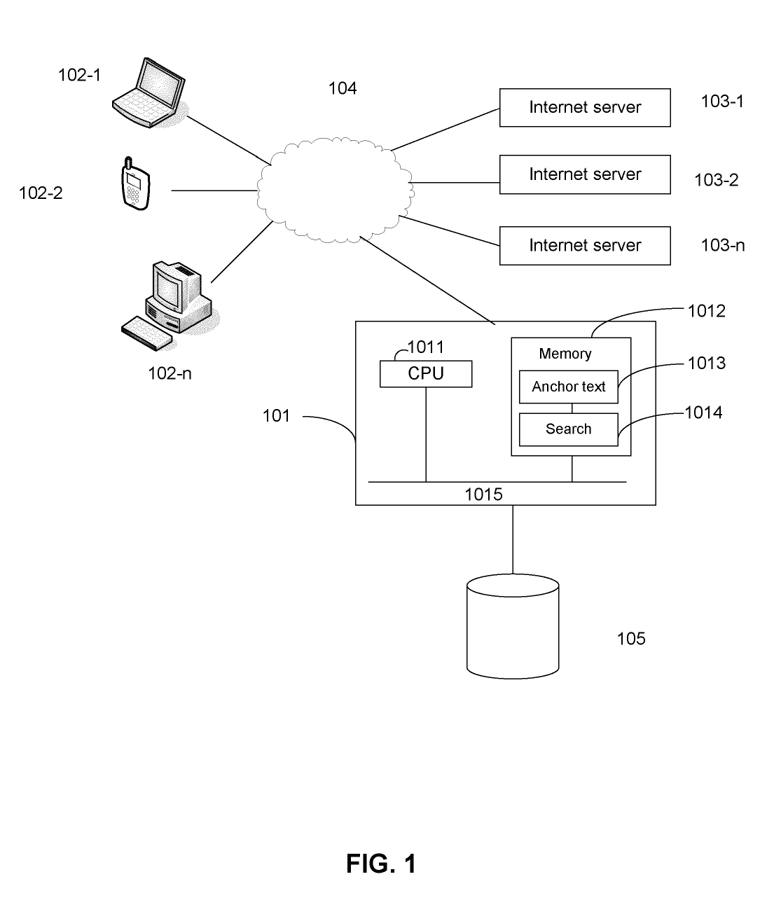

FIG. 1 illustrates a system for enriching document representations with aggregated anchor text according to one embodiment of the present invention. As shown, a number of user terminals 102-1, 102-2, . . . 102-n, a search server 101 and a number of Internet servers 103-1, 103-2, . . . 103-n may communicate with each other over a network 104. The search server 101 may aggregate anchor text for web pages over the web graph, store the aggregated anchor text in a database 105, and search documents enriched with aggregated anchor text when responding to a user query.

The user terminal 102-1, 102-2, . . . or 102-n may be a desktop computer, a laptop computer, a personal digital assistant (PDA), a smartphone, a set top box or any electronic devices having access to the network 104. A user terminal may have a CPU, a memory, a user interface, an interface to the computer network 104, and a display. The user terminal may also have a browser application configured to receive, display and publish web pages, which may include text, graphics, multimedia, etc. The web pages may be based on, e.g., HyperText Markup Language (HTML) or extensible markup language (XML). A user may include hyperlinks in a page when publishing it.

The Internet server 103-1, 103-2, . . . or 103-n may be a computer system, running a website or a blog. The website may have a number of web pages, and a web page may have a hyperlink pointing to another page within the site or outside of the site.

The network 104 may be, e.g., the Internet. Network connectivity may be wired or wireless, using one or more communications protocols, as will be known to those of ordinary skill in the art.

The search server 101 may be a computer system and may include a central processing unit (CPU) 1011 and a memory 1012, which communicate with each other and other parts in the computer system via a bus 1015. Alternatively, the search server 101 may include multiple computer systems each configured to accomplish certain tasks and coordinate with other computer systems to perform the method of the present invention.

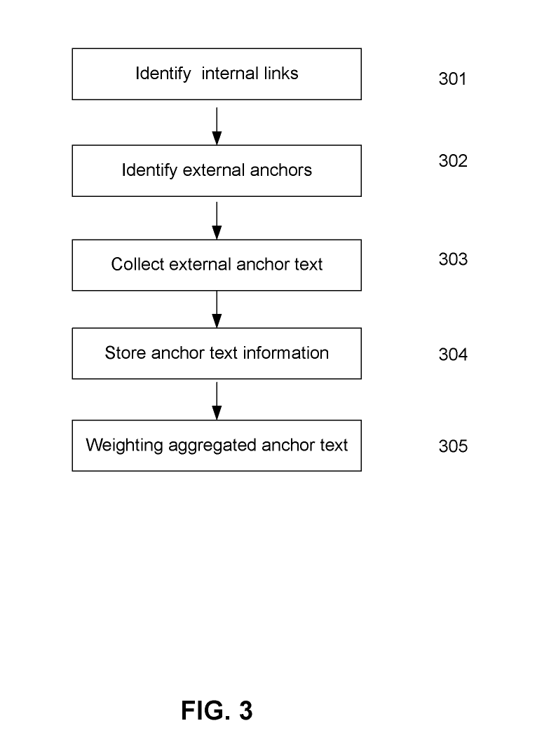

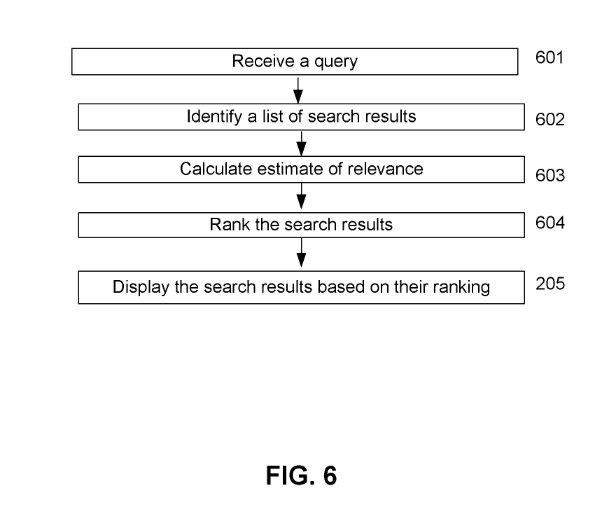

The CPU 1011 may perform computer software modules stored in the memory 1012 to carry out a number of processes, including but not limited to the one described below with reference to FIGS. 3 and 6. In one example, the CPU 1011 may execute an anchor text module 1013 stored in the memory 1012 to aggregate anchor text over the web graph, weight the aggregated anchor text, and store the anchor text information in the database 105. Document representations enriched with the weighted, aggregated anchor text may be stored in the database 105, although they may be stored in a separate database. The anchor text module 1013 may be a stand-alone module stored in the memory 1012, or integrated with a search module 1014. Alternatively, it may be stored in and performed by a separate server.

In one example, the CPU 1011 may execute a search module 1014 stored in the memory 1012 to receive a query over the network 104, identify web pages relevant to the query by searching documents enriched with the aggregated anchor text, calculate estimates of relevance of the web pages using combined weight for each line of anchor text, rank the web pages based on their estimates of relevance, and generate a search result page with the web pages being displayed as a list of search results.

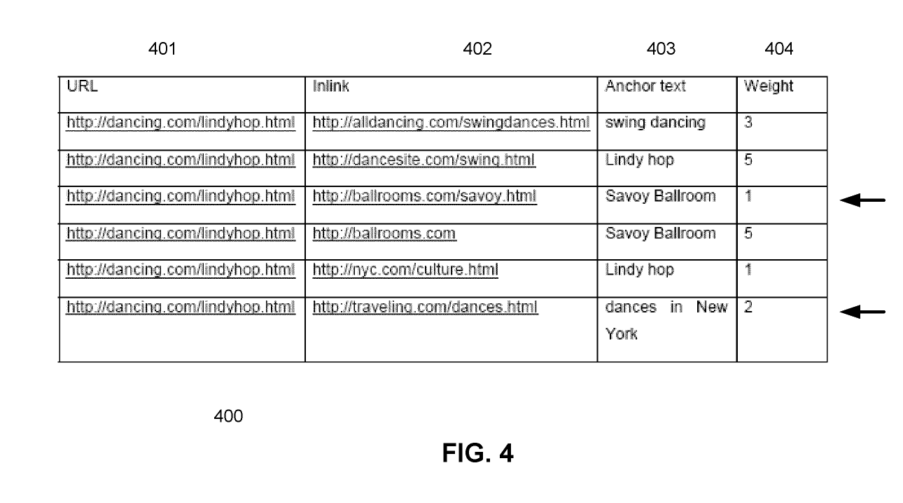

The database 105 may store anchor text information of web pages, which may include, e.g., their URLs, inlinks, anchor text lines and probably weights for the anchor text lines. A table stored in the database 105 will be described below, with reference to FIG. 4. Document representations enriched with the aggregated anchor text may be stored in the database 105 as well.

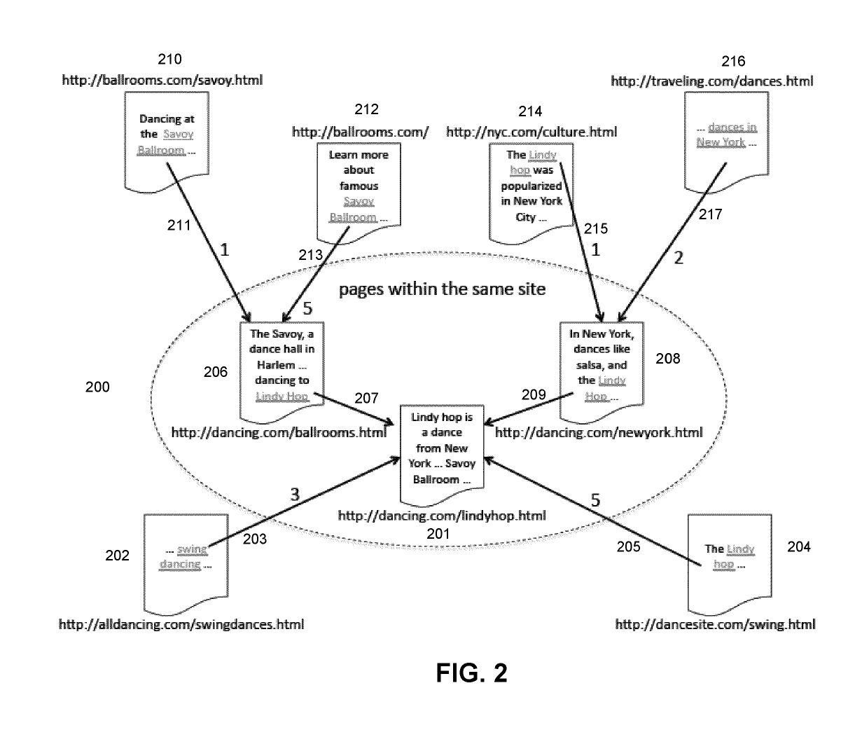

FIG. 2 illustrates a web graph over which anchor text may be aggregated according to one embodiment of the present invention. Anchor text may be aggregated for a target page 201 (URL: http://dancing.com/lindyhop.html), which may be related to dancing and may be within a site (or domain) 200.

A page 202 (URL: http://alldancing.com/swingdnaces.html) outside the site 200 may have a link 203 pointing to the target page 201. The anchor text of the link 203 may be, e.g., “swing dancing.” A page 204 (URL: http://dancesite.com/swing.html) outside the site 200 may have a link 205 pointing to the page 201. The anchor text of the link 205 may be, e.g., “Lindy hop.” The weights for links 203 and 205 may be, e.g., 3 and 5 respectively.

A page 206 (URL: http://dancing.com/ballrooms.html) may be within the site 200 containing the target page 201, and may have a link 207 pointing to the target page 201. The anchor text of the link 207 may be, e.g., “Lindy Hop.” A page 208 (URL: http://dancing.com/newyork.html) may be within the site 200, and may have a link 209 pointing to the target page 201. The anchor text of the link 209 may be, e.g., “Lindy Hop.” Links 207 and 209 may be called internal inlinks, since they come from within the same site containing the target page 201.

A page 210 (URL: http://ballrooms.com/savoy.html) may be outside the site 200, and may have a link 211 pointing to the page 206. The anchor text of the link 211 may be, e.g., “Savoy Ballroom.” A page 212 (http://ballrooms.com) may be outside the site 200, and may have a link 213 pointing to the page 206. The anchor text of the link 213 may be, e.g., “Savoy Ballroom.” The weights for links 211 and 213 may be, e.g., 1 and 5 respectively. The anchor text for links 211 and 213 may be called external anchor text, since they originate from pages outside of the site 200.

A page 214 (URL: http://nyc.com/culture.html) may be outside the site 200, and may have a link 215 pointing to the page 208. The external anchor text of the link 215 may be, e.g., “Lindy hop.” A page 216 (URL: http://traveling.com/dances.html) may be outside the site 200, and may have a link 217 pointing to the page 208. The external anchor text of the link 215 may be, e.g., “dances in New York.” The weights for links 215 and 217 may be, e.g., 1 and 2 respectively.

In the web graph shown in FIG. 2, the only anchor text information for the target page 201 available in conventional systems or applications is that of the links 203 and 205, e.g., “swing dancing” and “Lindy hop,” since anchor text from pages that do not directly link to the target page 201 is conventionally ignored. The present invention may add aggregated anchor text, or external anchor text, for the target page 201, e.g., “Savoy Ballroom” of links 211 and 213 and “dances in New York” of the link 217, so as to enrich the representation of the target page 201 and improve retrieval effectiveness.

Since internal inlinks, e.g., 207 and 209, typically link related pages within a given site, and are typically created by the owner of the site, they may be authoritative, as opposed to links originating from external sites, which may not be as purposefully generated. In addition, external anchors, e.g., 211, 213, 215 and 217, are less likely to be navigational and are more likely to provide good descriptions of their destination. Because internal links connect related pages, the external anchor text of the internal links may be good descriptors, by semantic transitivity, of the target page 201. This is why the external anchor text of the internal inlinks is used as the source of auxiliary anchor text.

In one embodiment, the anchor text associated with the internal inlinks, e.g., 207 and 209, may not be used, if such anchor text is navigational in nature (e.g., “home”, “next page”, etc.).

FIG. 3 illustrates a method for aggregating anchor text over the web graph according to one embodiment of the present invention.

At 301, for a given URL u, e.g., http://dancing.com/lindyhop.html for the target page 201, all pages P within the site (domain) 200 that link to u may be identified. As discussed above, these links are u's internal inlinks, since they come from within the same site 200. In the embodiment shown in FIG. 2, the set P may include pages 206 and 208 and the internal links may include links 207 and 209.

At 302, pages that are linked to P from outside the site 200 may be identified. These links are u's external anchors. In the embodiment shown in FIG. 2, external anchors may include, e.g., 211, 213, 215 and 217.

At 303, all anchor text A of external anchors may be collected. As discussed above, such anchor text is known as external anchor text, because it originates from pages outside of the site 200 containing the target page 201. In the embodiment shown in FIG. 2, the external anchor text may include, e.g., “Savoy Ballroom” for links 211 and 213, “Lindy hop” for the link 215, and “dances in New York” for the link 217. Thus, in short, the aggregated anchor text for u is the external anchor text of the internal inlinks of u.

At 304, the external anchor text information may be stored in the database 105. FIG. 4 illustrates an example of data stored in the database 105 according to one embodiment of the present invention. As shown, the data may be organized as a table having a number of columns: column 401 for the URL of the target page 201; column 402 for the URL of the inlinks, e.g., pages 202, 204, 210, 212, 214 and 216; and column 403 for the anchor text, e.g., “swing dancing” for the link 203, “Lindy hop” for the link 205, “Savoy Ballroom” for links 211 and 213, “Lindy hop” for the link 215, and “dances in New York” for the link 217. Each line in the table may represent an inlink and its anchor text. As mentioned above, anchor text information for pages 210, 212, 214 and 216 may be external anchor text of the internal inlinks of the target page, and may be aggregated by the present invention over the web graph.

A line of anchor text associated with a URL may have some weight assigned to it. As shown in FIG. 2, the weight for the anchor text “Savoy Ballroom” may be 1 for the link 211, and 5 for the link 213; the weight for the anchor text “Lindy hop” may be 1 for the link 215 and 5 for the link 205; the weight for the anchor text “dances in New York” for the link 217 may be 2; and the weight for the anchor text “swing dancing” may be 3 for the link 203. A weight may be stored in the table 400, in column 404 and the line for the anchor text it is assigned to.

Since lines of anchor text may be aggregated from multiple sources, it is possible that the same line of aggregated anchor text may originate from multiple URLs, each with a potentially different weight. For example, the weight for “Savoy Ballroom” is 1 for the link 211 and 5 for the link 213. Since only one weight per distinct line of anchor text may be needed, the weights of lines originating from multiple sources may be combined in some way, at 305. In one embodiment, standard result set fusion techniques may be applied to combine the weights.

In one embodiment, the following weight aggregation functions may be used to weight the aggregated lines of anchor text:

$$\begin{matrix}{wt}_{Min} ( l , u ) = {min}_{u ∈ N ( u )} wt ( l , {u}^{′} ) & ( 1 ) \\ {wt}_{Max} ( l , u ) = {max}_{u ∈ N ( u )} wt ( l , {u}^{′} ) & ( 2 ) \\ {wt}_{Mean} ( l , u ) = \frac{1}{\vert N ( u ) \vert} {\sum }_{{u}^{′} ∈ N ( u )} wt ( l , {u}^{′} ) & ( 3 ) \\ {wt}_{Sum} ( l , u ) = {\sum }_{{u}^{′} ∈ N ( u )} wt ( l , {u}^{′} ) & ( 4 ) \\ {wt}_{MeanMNZ} ( l , u ) = \frac{\vert {u}^{′} ∈ N ( u ) \text{:} wt ( l , {u}^{′} ) > 0 \vert}{\vert N ( u ) \vert} {\sum }_{{u}^{′} ∈ N ( u )} wt ( l , {u}^{′} ) & ( 5 ) \\ {wt}_{SumMNZ} ( l , u ) = \vert {u}^{′} ∈ N ( u ) \text{:} wt ( l , {u}^{′} ) > 0 \vert {\sum }_{{u}^{′} ∈ N ( u )} wt ( l , {u}^{′} ) & ( 6 )\end{matrix}$$

where N(u) is the set of internal inlinks and wt(l,u′) is the original weight of anchor text line l for URL u′. If some line of aggregated anchor text originates from a single URL u′, then the aggregated weight will equal wt(l,u′) regardless of the aggregation function chosen. However, when a line originates from multiple URLs, each of the aggregation functions computes the weight differently.

In one embodiment, the MIN function (1) may be used to select the minimum weight from multiple different weights. Using the MIN function (1), the weights for the aggregated anchor text for the target page 201 may be:
Savoy Ballroom: weight=1;
Lindy hop: weight=1; and
Dances in New York: weight=2.

In one embodiment, weights of “Lindy hop,” including 1 for the link 215 and 5 for link 205 may be considered as well.

In one embodiment, the MAX function (2) may be used to select the maximum weight from multiple different weights. Using the MAX function (2), the weights for the aggregated anchor text for the target page 201 may be:
Savoy Ballroom: weight=5;
Lindy hop: weight=1; and
Dances in New York: weight=2.

In one embodiment, the MEAN function (3) may be used to calculate the mean value of multiple different weights. Using the MEAN function (3), the weights of the aggregated anchor text for the target page 201 may be:
Savoy Ballroom: weight=3;
Lindy hop: weight=1; and
Dances in New York: weight=2.

In one embodiment, the SUM function (4) may be used to calculate the sum of multiple different weights. Using the SUM function (5), the weights for the aggregated anchor text for the target page 201 may be:
Savoy Ballroom: weight=6;
Lindy hop: weight=1; and
Dances in New York: weight=2.

Similarly, functions (5) and (6) may be used to calculate the weights as well.

The original anchor text line weights (i.e., wt(l,u′)) may be computed differently for every search engine implementation. In one embodiment, original lines of anchor text may be weighted as follows:

$$wt ( l , u ) = {\sum }_{s ∈ S ( u )} \frac{δ ( l , u , s )}{\vert anchors ( u , s ) \vert} \qquad ( 7 )$$

where S(u) is the set of external sites that link to u, δ(l,u,s) is 1 if and only if anchor text l links to u from some page within site s, and |anchors(u,s)| is the total number of unique anchors originating from site s that link to u.

Thus, the input to the method may be a URL u of the target page 201, and the output may be a weighted set of aggregated anchor text lines. This may be achieved in two steps. First, the aggregated anchor text lines may be collected by 301 to 303. Then, the lines may be combined and weighted to produce the final result at 305.

The aggregated anchor text collected and weighted may be used in various ways to build enriched document representations. Aggregated anchor text-enriched document representations may be useful for various information retrieval and natural language processing tasks including, e.g., web search, content match, text classification, and summarization. The best representation will depend on the task. Four possible representations will be discussed below:

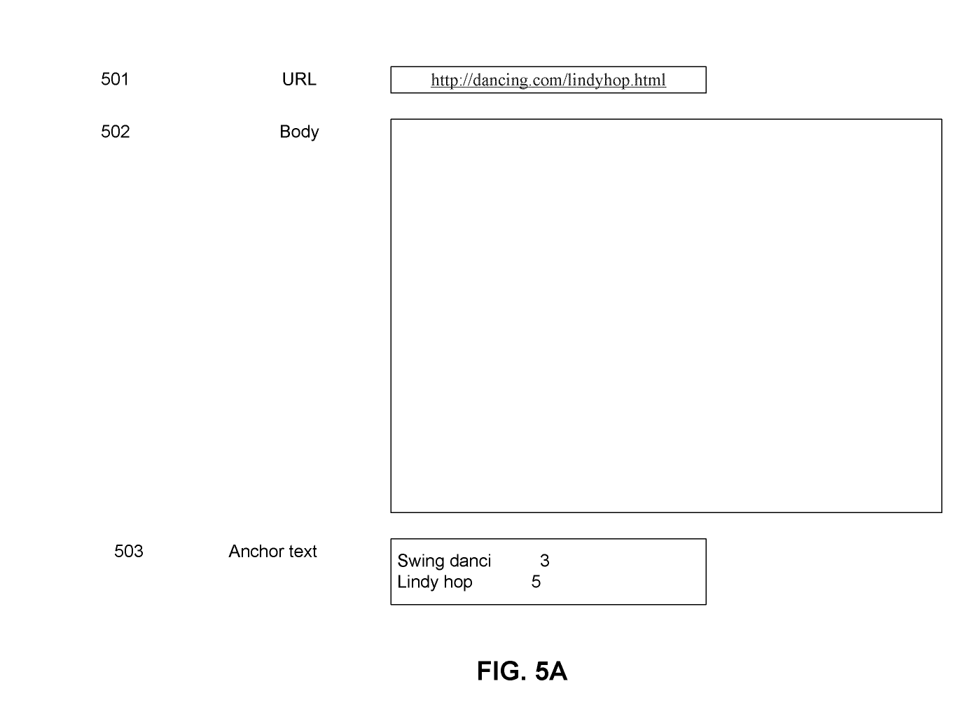

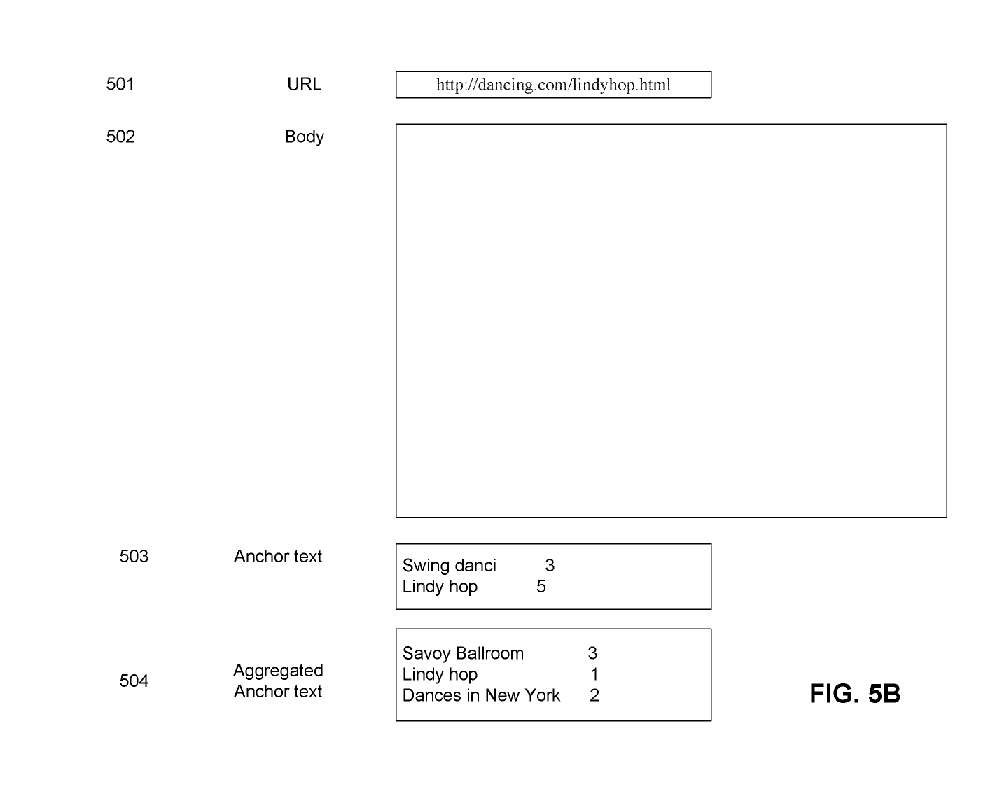

The first representation is the flat representation. As shown in FIG. 5A, a representation of a document, e.g., the target page 201, may include its URL 501 and body 502, and maybe some fields, e.g., a field 503 for anchor text. For the flat representation, all document structure, such as fields, formatting, and metadata, may be ignored. The aggregated anchor text weights may be discarded and only the raw text itself may be added to the original document body 502. This representation is one very simple possibility.

The second representation is the combined representation, which may preserve the document structure, and augment the original anchor text lines in the field 503 with the aggregated anchor text lines. The aggregated anchor text weights may also be used here, as long as the search engine's indexing architecture supports it.

One issue with the combined representation is that there may be some overlap between the original and aggregated anchor text lines, such as “Lindy hop” for the link 215 in the aggregated anchor text and “Lindy hop” for the link 205 in the original anchor text compiled by conventional systems. The aggregated anchor text lines may add noise to a set of high quality original anchor text lines. To overcome this issue, the backoff representation may only add aggregated anchor text to documents that do not originally have any anchor text lines associated with them.

The fourth representation is a new field representation which adds the aggregated anchor text as a completely new field to every document, as shown in FIG. 5B. Unlike the combined and backoff representations that add the aggregated anchor text to the original anchor text field, the new field representation treats the new lines of anchor text as a new source of evidence, by adding them in a new field 504 for aggregated anchor text. This may be useful for textual features, such as BM25F, that weight the importance of each field separately. In this representation, the original and aggregated anchor text fields can be weighted differently, which may be useful.

The enriched document representations result in significant improvements in retrieval effectiveness on a very large web test collection. During one evaluation, the method of the invention not only reduced the number of pages with no anchor text by 38%, but also added, on average, 34 lines of anchor text to every URL.

FIG. 6 is a flow chart of a method for using aggregated anchor text to improve Internet search according to one embodiment of the present invention.

At 601, a search query may be received from a user terminal, e.g., 102-1, over the network 104.

At 602, the search server 101 may search documents representations of web pages, which are enriched with the aggregated anchor text, to identify web pages relevant to the query.

At 603, the search server 101 may calculate estimates of relevance of the web pages, using the combined weight for each line of anchor text.

At 604, the search server 101 may rank the web pages based on their estimates of relevance.

At 605, the search server 101 may generate a search result page, with the web pages being displayed as a list of search results.

Several features and aspects of the present invention have been illustrated and described in detail with reference to particular embodiments by way of example only, and not by way of limitation. For example, the aggregated anchor text may be collected and weighted in many different ways beyond the approaches described here. Also, in addition to web search, the enriched document representations may be used in a number of other ways, including estimating improved document models, developing advanced textual matching features, and even improving the quality of document classification algorithms.

Those of skill in the art will appreciate that alternative implementations and various modifications to the disclosed embodiments are within the scope and contemplation of the present disclosure. Therefore, it is intended that the invention be considered as limited only by the scope of the appended claims.

What is claimed is:

1. A computer implemented method comprising:
receiving a URL of a target page;
identifying at least one internal inlink, which is a page pointing to the target page and within a site containing the target page;
identifying at least one external anchor that points to the at least one internal inlink from a page outside of the site;
collecting anchor text of the at least one external anchor; and
storing in a database the external anchor text of the at least one internal inlink as aggregated anchor text of the target page.

2. The method of claim 1, further comprising: when external anchor text of a first external anchor and a second external anchor has the same line of text but different weights, combining the weights.

3. The method of claim 2, further comprising: using a function selected from the group consisting of following functions to combine the weights:
$$\begin{matrix}{wt}_{Min} ( l , u ) = {min}_{u ∈ N ( u )} wt ( l , {u}^{′} ) & ( 1 ) \\ {wt}_{Max} ( l , u ) = {max}_{u ∈ N ( u )} wt ( l , {u}^{′} ) & ( 2 ) \\ {wt}_{Mean} ( l , u ) = \frac{1}{\vert N ( u ) \vert} {\sum }_{{u}^{′} ∈ N ( u )} wt ( l , {u}^{′} ) & ( 3 ) \\ {wt}_{Sum} ( l , u ) = {\sum }_{{u}^{′} ∈ N ( u )} wt ( l , {u}^{′} ) & ( 4 ) \\ {wt}_{MeanMNZ} ( l , u ) = \frac{\vert {u}^{′} ∈ N ( u ) \text{:} wt ( l , {u}^{′} ) > 0 \vert}{\vert N ( u ) \vert} {\sum }_{{u}^{′} ∈ N ( u )} wt ( l , {u}^{′} ) & ( 5 ) \\ {wt}_{SumMNZ} ( l , u ) = \vert {u}^{′} ∈ N ( u ) \text{:} wt ( l , {u}^{′} ) > 0 \vert {\sum }_{{u}^{′} ∈ N ( u )} wt ( l , {u}^{′} ) & ( 6 )\end{matrix}$$

4. The method of claim 2, further comprising: using the aggregated anchor text to enrich a document representation of the target page.

5. The method of claim 4, wherein the aggregated anchor text is added to a body of the document.

6. The method of claim 4, wherein the aggregated anchor text is added to a field for anchor text.

7. The method of claim 4, wherein the aggregated anchor text is added as a new field.

8. The method of claim 4, further comprising:
receiving a search query; and
searching web pages, whose document representations are enriched with aggregated anchor text, to identify web pages relevant to the query.

9. The method of claim 8, further comprising: calculating estimates of relevance of the web pages, using the combined weight for the aggregated anchor text.

10. A computer system comprising:
a processor for receiving a URL of a target page; identifying at least one internal inlink, which is a page pointing to the target page and within a site containing the target page; identifying at least one external anchor that points to the first internal inlink from a page outside of the site; and collecting anchor text of the at least one external anchor; and
a data storage device for storing the external anchor text of the at least one internal inlink as aggregated anchor text of the target page.

11. The computer system of claim 10, wherein the data storage device further storing a weight assigned to the aggregated anchor text.

12. A computer program product comprising a computer-readable medium having instructions which, when performed by a computer, perform a method comprising:
receiving a URL of a target page;
identifying at least one internal inlink, which is a page pointing to the target page and within a site containing the target page;
identifying at least one external anchor that points to the at least one internal inlink from a page outside of the site;
collecting anchor text of the at least one external anchor; and
storing in a database the external anchor text of the at least one internal inlink as aggregated anchor text of the target page.

13. The computer program product of claim 12, wherein the method further comprises: when the external anchor text of a first external anchor and a second external anchor has the same line of text but different weights, combining the weights.

14. The computer program product of claim 13, wherein the method further comprises: using a function selected from the group consisting of following functions to combine the weights:
$$\begin{matrix}{wt}_{Min} ( l , u ) = {min}_{u ∈ N ( u )} wt ( l , {u}^{′} ) & ( 1 ) \\ {wt}_{Max} ( l , u ) = {max}_{u ∈ N ( u )} wt ( l , {u}^{′} ) & ( 2 ) \\ {wt}_{Mean} ( l , u ) = \frac{1}{\vert N ( u ) \vert} {\sum }_{{u}^{′} ∈ N ( u )} wt ( l , {u}^{′} ) & ( 3 ) \\ {wt}_{Sum} ( l , u ) = {\sum }_{{u}^{′} ∈ N ( u )} wt ( l , {u}^{′} ) & ( 4 ) \\ {wt}_{MeanMNZ} ( l , u ) = \frac{\vert {u}^{′} ∈ N ( u ) \text{:} wt ( l , {u}^{′} ) > 0 \vert}{\vert N ( u ) \vert} {\sum }_{{u}^{′} ∈ N ( u )} wt ( l , {u}^{′} ) & ( 5 ) \\ {wt}_{SumMNZ} ( l , u ) = \vert {u}^{′} ∈ N ( u ) \text{:} wt ( l , {u}^{′} ) > 0 \vert {\sum }_{{u}^{′} ∈ N ( u )} wt ( l , {u}^{′} ) & ( 6 )\end{matrix}$$

15. The computer program product of claim 13, wherein the method further comprises: using the aggregated anchor text to enrich a document representation of the target page.

16. The computer program product of claim 15, wherein the aggregated anchor text is added to a body of the document.

17. The computer program product of claim 15, wherein the aggregated anchor text is added to a field for anchor text.

18. The computer program product of claim 15, wherein the aggregated anchor text is added as a new field.

19. The computer program product of claim 15, wherein the method further comprises:
receiving a search query; and
searching web pages, whose document representations are enriched with aggregated anchor text, to identify web pages relevant to the query.

20. The computer program product of claim 19, wherein the method further comprises:
calculating estimates of relevance of the web pages, using the combined weight for the aggregated anchor text.
